(19) United States
(12) Patent Application Publication
(10) Pub. No.: US 2012/0110932 A1
(43) Pub. Date: May 10, 2012

(54) PAN TILE/ROOFING TILE/FACADE ELEMENT WITH INTEGRATED SOLAR MODULE

(75) Inventors: Hubert Ehbing, Odenthal (DE); Frank Schauseil, Leverkusen (DE); Lutz Liebegott, Leverkusen (DE)

(73) Assignee: Bayer MaterialScience AG, Leverkusen (DE)

(21) Appl. No.: 13/376,393

(22) PCT Filed: May 28, 2010
(86) PCT No.: PCT/EP2010/003269

§ 371 Date: Jan. 12, 2012

(30) Foreign Application Priority Data
Jun. 6, 2009 (DE) 10 2009 024 524.3

(51) Int. Cl. E04D 13/18; B28B 5/00

(52) U.S. Cl. 52/173.3; 264/250

(57) ABSTRACT

The present invention relates to a roofing tile, a roofing shingle or facade element having a photovoltaic solar element and a method for producing such a roofing tile/roofing shingle/facade element.

The present invention relates to a roofing tile, a roofing shingle or facade element having a photovoltaic solar panel and a method for producing such a roofing tile/roofing shingle/facade element.

A solar panel converts sunlight directly into electric energy. Solar panels are used singly or connected to arrays, for example, in photovoltaic systems, small loads independent of the power grid, or for power supply for spacecraft.

In order to meet the requirements for a system for solar-generated power, solar cells are combined to a solar panel using a variety of materials. Usually, a solar panel includes a framed assembly consisting of a glass pane, a transparent plastic layer, mono- or polycrystalline solar cells, and a backside barrier film.

The glass pane serves as a front cover and for protection against mechanical effects and the effects of weather. It must have an extremely high transparency in order to keep absorption losses in the optical range of the spectrum and thus losses in efficiency as low as possible. A glass pane made of single pane safety glass (SPSG), which has a high resistance to temperature variations, is usually employed.

The transparent plastic layer includes encapsulant films in which the solar cells are embedded. In particular, EVA (ethylene-vinyl acetate) films, but also TPU (thermoplastic polyurethane) films, PVB (polyvinylbutyral) films and/or silicone encapsulants are employed as encapsulant films. These materials serve for adhesively bonding the entire panel assembly together. The solar cells made of silicon are electrically connected with one another by soldering ribbons. The backside of the assembly is formed from a weatherproof composite plastic sheet, for example, of polyvinyl fluoride and/or polyester.

The production of a solar panel mostly starts with the glass panel, with the side facing away from the sun. To the appropriately cleaned glass, an EVA film is applied. The connected solar cells are positioned on the pane with the EVA film. Subsequently, all is covered by another EVA film and a backside film. During a lamination process at about 150° C., the EVA film melts, flows into the interstices between the soldered solar cells, and is thermally cross-linked. From the previously milky EVA film, a clear three-dimensionally cross-linked plastic layer forms, which can no longer be molten and in which the solar cells are now embedded and firmly bonded with the glass pane and the backside film. The formation of bubbles, which would lead to reflection losses, is avoided by effecting the lamination under vacuum. The panel backside formed from composite sheet protects the solar cell and the encapsulant material from moisture and oxygen. Moisture or oxygen may cause corrosion of the metal contacts and chemical degradation of the EVA encapsulant material.

Corrosion may cause complete failure of a solar panel, since normally all the solar cells in a panel are electrically connected in series. A degradation of the EVA is shown by a yellowing of the panel associated with a performance reduction by light absorption, and a visual deterioration. Other than a composite sheet, another glass pane may be used as a backside laminated layer.

Solar panels are usually provided with a frame of aluminum. The latter protects the glass pane during transport, handling and mounting; it further serves for attaching and stiffening the composite.

In addition to the use of solar panels in space technology or in small loads independent of the power grid, such panels are also increasingly used in supplying (private) households with electric power. For this purpose, solar panels are attached to the roof. In doing so, it must be taken into account that such solar panels have a considerable weight themselves. It affects the statics of the roof and thus of the whole house. If the solar panels are employed instead of conventional roofing tiles/roofing shingles, an inhomogeneous appearance of the roof is obtained. The same applies to the use of facade solar panels. Similarly, these result in an inhomogeneous appearance of the outer wall of a building.

Several manufacturers of roof coverings offer solar roofing shingles. Systems available in the market, such as CSS® solar roofing shingles (Creative Solar Systems GmbH, Suhl-Wichtshausen, Germany), solar systems of the company Braas (Monier GmbH, Oberursel, Germany), KoraSun® of the company Koramic (Kortrijk, Belgium) or PREFA SOLAR® (Prefa GmbH, Wasungen and Bergisch-Gladbach, Germany), often have the size of several conventional roofing shingles/roofing tiles and either replace several thereof or are applied in addition to the existing roofing shingles/roofing tiles.

To date, photovoltaic solar panels have been known in various shapes or encasings that do not correspond in appearance to the traditional outer shapes of roofing shingles or roofing tiles, or facade elements. In the prior art, various possibilities for the integration of solar panels into roofings have been known.

Thus, DE 198 27 776 A1 and DE 200 10 620 U1 deal with a transparent roof tile/roofing tile. A solar panel is provided below the optically transparent roof tile or roofing tile.

DE 33 14 637 A1 relates to a roofing shingle for the overlapping coverage of inclined roof areas, in which semiconductor photovoltaic elements are provided in the area not covered by neighboring roofing shingles, and the roofing shingle has a hollow space below the semiconductor photovoltaic elements that is connected with the hollow spaces of the underlying and overlying roofing shingles.

DE 103 56 690 B4 relates to a solar panel for roof integration consisting of several crystalline silicon cells commonly provided with a transparent cover into which a number of depressions corresponding to the number of silicon cells for receiving the silicon cells are provided on the side facing away from the sun with a depth corresponding at least to the thickness of the silicon cells.

DE 203 04 099 U1 deals with a mechanical fixing device that can be attached to a roofing tile. The fixing device serves for detachably attaching an object, especially a solar module, by which the position of the received object relative to the roof covering element can be changed and set, wherein said fixing device has at least one support element extending beyond the roof covering element and connected with an adjustable receiving head by which the object can be held. Such a fixing device is suitable for a wide variety of roofing tile types. U.S. Pat. No. 5,409,549 A, EP 0 440 103 A2 and EP 0 710 806 B1 also deal with the mechanical mounting of solar panels on roofing tiles or roofing shingles.

DE 199 53 466 A1 deals with a large size solar roofing shingle. Its base body consists of a specific polymer concrete, whereby a favorable temperature behavior in terms of the photovoltaic yield is achieved. Due to the particular strength and elasticity properties of the roofing shingle, tiling principles promoting the tightness of the roof can be realized.

DE 296 16 015 U1 relates to a device for the roofing of buildings and other facilities with outer contours of commercially available roofing shingles or roofing tiles, but which are produced from a wide variety of materials and integrated into the photovoltaic solar panels for generating electric power. For example, the roof tiles are produced from recycled plastic. The photovoltaic solar panel is incorporated into the solar roofing shingle by means of detachable joining means.

DE 10 2005 050 884 A1 deals with a photovoltaic panel and a method for the preparation thereof, and a system consisting of several photovoltaic panels. The specification relates to photovoltaic panels, for example, for use in the designing of roofings or facade surfaces, and especially relates to a photovoltaic panel with a holding frame, a method for the preparation thereof, and a system with several of those photovoltaic panels.

Also, JP 2004132123 A deals with the mounting of a solar panel on a roofing tile or roofing shingle. The solar panel is provided on the roofing material. The electrical connections are on the backside of the solar panel, the roofing material having recesses for these connections.

In DE 44 11 458 A1, solar panels are later pressed into the roof tiles of a roof that had at first been conventionally tiled, and fixed so as not to slide. This is enabled by laterally extending elastic protrusions on the solar panels. These can adapt to a wide variety of dimensional deviations of the roofing tile/roofing shingle, so that a safe and secure support is always ensured. The protrusions on the solar panel contain a plurality of microvessels in which an adhesive is contained in the form of a non-metallic material, especially a plastic material, for example, silicone.

In addition to the mechanical attachment of the solar panel on a roofing tile or a roofing shingle, it is also possible to attach a solar panel directly by adhesive bonding. DE 39 32 573 C3 deals with concrete roofing shingles with an extruded and/or rolled-on surface coating in general, and with a method and device for the preparation thereof.

DE 100 48 034 B4 deals with a glassless flexible solar laminate containing a self-adhesive layer with electrical cables on the backside thereof. A solar laminate is a frameless embedding of crystalline solar cells between glass or transparent plastic layers.

Roofing shingles or roofing tiles and roof panel systems are also utilized in DE 10 2005 032 826 A1, wherein a solar cell coating is applied (adhesively bonded) to the base or support material.

JP 2004162443 A deals with organic solar cells. These are provided on a resin-based roofing tile or roofing shingle.

However, the integration of solar panels into the roof surface is complicated and expensive, since specific fixing devices or additional parts, additional seals and an increased expenditure for mounting and for service work are necessary. The incorporation of the solar panels often requires an additional operation, which ultimately leads to an increased price for solar electricity. In addition, the load weight is increased. In addition to the roofing shingles/roofing tiles, the solar panels also rest on the building, which must be taken into account when the statics are calculated. The additional load weight in the cladding of houses is also to be taken into account.

Thus, an improvement of this method would be the incorporation of a solar panel directly into a roofing tile/roofing shingle/facade element. The bonding must ensure permanent adhesion between the solar panel and the roofing shingle/roofing tile/facade element. Just for facade elements applied vertically to the wall of the building, such permanent adhesion is critical lest the solar panels should became detached from the facade elements and fall down. Permanent connections between solar panels and polymeric materials are known.

Thus, U.S. Pat. No. 5,743,970 A describes a photovoltaic solar panel that is completely embedded in a polymeric material. Similarly, EP 1 225 642 A1 describes solar panels with polyurethane encapsulation and a process for the preparation thereof. The front side thereof consists of a transparent polyurethane.

U.S. Pat. No. 4,830,038 and U.S. Pat. No. 5,008,062 deal with a solar panel that is protected against moisture and isolated by an elastomer applied to the backside, the sides and in part the front side of the solar panel.

When a solar panel is incorporated into a roofing shingle/roofing tile/facade element, stresses between the solar panel and the roofing shingle/roofing tile/facade element caused by temperature variations must be taken into account.

The bonding between a flat glass and a polymer artificial stone by means of a plastic material is described in DE 199 33 178 A1. A glass-filled polymer artificial stone is inseparably bonded with a scratch-resistant flat glass pane. The flat glass pane is provided with a layer of polyvinyl acetate, and during the production, at least the core layer of the polymer artificial stone is employed as an already cured molded part. The polymer artificial stone consists of a resin of unsaturated polyester (UP resin) filled with glass granules. In addition to flat glass panes, solar panels are also used as described in DE 199 58 053 A1. The power-generating molded parts are constituted of four layers. The uppermost layer is a flat glass pane coated with thin film solar cells and provided with an elastic adhesion-promoting layer of highly transparent polyvinyl acetate (PVAC). The third layer is a decorative layer of polymer artificial stones based on a UP resin filled with glass granules. The base layer also consists of polymer artificial stone, which is employed as an already cured molded part, while the decorative layer is employed while still uncured.

Thus, the object of the present invention is to provide a roofing tile/roofing shingle/facade element with a photovoltaic solar panel. As an improvement over the prior art, the solar module should be permanently connected with the roofing tile/roofing shingle/facade element. The connection must have a sufficient weather resistance in order to prevent the ingress of moisture. The solar panel should not exert an additional load weight on the roof construction or the masonry. Thus, the solar panel should be integrated in the roofing shingle/roofing tile/facade element. Since the corresponding solar roofing tile/roofing shingle/facade elements are incorporated into the roof construction or the house construction in general, they must meet the requirements according to DIN 4102-7 in accordance with the Building Code in Germany. In particular, they must exhibit resistance against flying sparks and radiated heat. Therefore, it is a further object of the present invention to design the solar roofing tile/solar roofing shingle/solar facade element so as to have sufficient flame retardancy.

The solar roofing shingle/solar roofing tile/solar facade element should not be distinguished from conventional roofing shingles/roofing tiles/facade elements in optical terms and, above all, in terms of color.

In a first embodiment, the object of the invention is achieved by a roofing tile/roofing shingle/facade element with a photovoltaic solar panel, characterized in that said solar panel is embedded in polyurethane, preferably an elastomeric polyurethane, on the backside thereof and laterally/circumferentially.

In a further preferred embodiment, a solar panel without a backside film is provided. In this case, the solar panel comprises a glass pane and solar cells embedded in EVA film, but no backside protective film. According to the invention, such a solar composite is also embedded in polyurethane, preferably an elastomeric polyurethane, on the backside thereof and laterally/circumferentially.

The roofing tile/roofing shingle/facade element further has a polymer concrete, especially a concrete containing polyurethane. It is provided laterally/circumferentially and on the backside of the framed solar panel. If the solar panel has no backside composite sheet, the polymer concrete takes over the moisture and oxygen barrier function of this omitted expensive backside composite sheet.

A polymer concrete is a composite material of an organic binder and inorganic fillers, optionally with the addition of hardeners, accelerators, inhibitors, flame retardants or other additives. As compared to conventional concretes, polymer concretes are characterized by improved performance characteristics, a lower amount of processing and a longer service life. They enable a good heat dissipation, which leads to a higher yield of the solar cells. Upon full solar irradiation, the modules show a heat build-up of up to 80° C., which results in a temperature-related deterioration of the efficiency of the solar cells and thus ultimately to a higher cost of solar electricity. The function of the polymer concrete is to avoid this.

When a roofing tile/roofing shingle/facade element is prepared, a shrinkage can be observed like with conventional concrete. “Shrinkage” describes a volume reduction of cement stone due to desiccation. UP resins frequently used in polymer concrete have a shrinkage of about 9%. A solar panel in contact with a polymer artificial stone consisting of a UP resin naturally cannot reproduce such shrinkage. Due to the shrinkage of the UP polymer concrete, the solar panel is subjected to such a high mechanical load during the curing that it breaks or the solar cells are damaged. It bends concave or convex depending on from which side the panel is viewed.

A polyurethane used in the polymer concrete according to the invention has a shrinkage of only 0.9 to 1.5%, especially 1.2%.

The shrinkage can be further reduced by adding one or more fillers. Thus, the polyurethane according to the invention can be admixed with from 50 to 85% by weight, especially 70% by weight, of a filler, for example, sand, for the preparation of a polymer concrete. In order to obtain a homogeneous product and at the same time a high proportion of filler, the sand may contain a mixture of mutually complementing grain sizes from different grain size distributions. Preferably, these grain sizes comprise a range of diameters of from 0.3 to 1 mm. Such a sand-filled concrete has a shrinkage of less than 0.5%, especially less than 0.3%. The shrinkage of the polymer concrete does not change by the addition of anti-ageing, flame retardant and coloring agents either. Such a low shrinkage enables an inseparable bonding between a photovoltaic solar panel and a roofing tile/roofing shingle.

Preferably, the polymer concrete of the roofing tile/roofing shingle/facade element according to the invention comprises at least one flame retardant. According to the present invention, “flame retardant” means, in particular, organic compounds (especially halogenated, phosphorus-containing, for example, tricresyl phosphate, tris(2-chloroethyl)phosphate, tris(chloropropyl)phosphate, and tris(2,3-dibromopropyl)phosphate, and nitrogen-containing organic compounds) as well as inorganic phosphorus compounds (for example, red phosphorus, ammonium polyphosphate), inorganic metal hydroxides (for example, aluminum trihydroxide, aluminum oxide hydrate, ammonium polyphosphate, sodium polymetaphosphate or amine phosphates, for example, melamine phosphates) and inorganic boron compounds (for example, boric acid, borax).

Examples of commercially available flame retardants that may be applied within the scope of the present invention include, for example: Disflamoll® DPK (diphenyl cresyl phosphate), Levagard® DMPP (dimethylpropane phosphonate), Levagard® PP (tris(2-chloroisopropyl)phosphate), melamine, Exolite® AP 422 (a free-flowing powdery, hardly water-soluble ammonium polyphosphate of formula (NH₄PO₃)ₙ with n=20 to 1000, especially 200 to 1000), Apyral® (Al(OH)₃).

Melamine is particularly preferred as a flame retardant.

The solar panel itself is at first provided with an adhesion promoter on the backside and laterally/circumferentially. To this adhesion promoter, a frame of polyurethane (PU frame) is applied also on the backside and laterally/circumferentially. Aliphatic and/or aromatic components are employed to form the polyurethane. According to the invention, this frame has a thickness of from 1 to 5 mm, especially from 2 to 3 mm. Optionally, on the front side, i.e., the glass side of the solar element, there may be provided a circumferential finished edge, which does not overlap with the solar cell, however.

It is important that the transition between the solar element, the PU frame and the roofing shingle/roofing tile/facade element is even and does not involve a step, edge or similar unevenness, for rainwater and dirt could accumulate therein. A dirt layer reduces the transparency of the glass pane and thus the yield of solar electricity.

By the adhesion promoter, the polyurethane is firmly bonded to the solar cell. The ingress of oxygen or moisture is avoided. A thickness of the frame according to the invention ensures a permanent adhesion of the solar panel within the roofing tile/roofing shingle/facade element by compensating any stresses between the solar panel and the roofing tile/roofing shingle/facade element. Such stresses can be caused, for example, by temperature variations. The polymer concrete and the solar element have different thermal expansion coefficients. During intensive solar irradiation, the materials exhibit different expansions, and during frost, they show different contractions accordingly. This difference in thermal expansion is compensated by the polyurethane frame.

Further, it is possible for the frame of the solar module to contain isotropic and/or anisotropic fillers, anisotropic and especially acicular and/or fibrous fillers being particularly preferred.

According to the present invention, “fillers” means organic and/or inorganic compounds, preferably organic and/or inorganic compounds except for:

a) organic compounds that are halogenated, phosphorus-containing or nitrogen-containing; and

b) inorganic phosphorus compounds, inorganic metal hydroxides and inorganic boron compounds.

The groups of compounds stated under a) and b) are preferably classified under flame retardants according to the present invention.

The advantage of anisotropic acicular and/or fibrous fillers resides in their orientation within the polymer and the particularly low thermal expansion and shrinkage values caused thereby.

The amount of the fillers contained in the frame is preferably within a range of from 10 to 30% by weight, more preferably within a range of from 15 to 25% by weight, based on the weight of the polyurethane.

In addition to the R-RIM (reinforced reaction injection molding) method, high contents of reinforcing agents in filled polyurethanes can be produced, for example, with a fiber spray method or the so-called S-RIM (S=structural) method. In the fiber spray method, a fiber-polyurethane mixture is sprayed onto the desired place into the mold. Subsequently, the mold closes, and the PUR system reacts to completion. In the S-RIM method, a preformed (continuous) fiber structure is inserted into the (frame) mold, and then the PUR reaction mixture is injected into the mold while it is still open or when it has closed.

Further, the preparation of a frame with high fiber contents is possible by the RTM (resin transfer molding) method, in which a fiber structure inserted into the mold is in turn impregnated with vacuum support.

Preferably, the fillers are synthetic or natural, especially mineral, fillers. More preferably, the fillers are selected from the following group: mica, plate-like and/or fibrous wollastonite, glass fibers, carbon fibers, aramide fibers or mixtures thereof. Among these fillers, fibrous wollastonite is preferred because it is inexpensive and readily available.

Preferably, the fillers additionally have a coating, especially an aminosilane-based coating. In this case, the interaction between the fillers and the polymer matrix is enhanced. This results in better performance characteristics since the coating permanently couples the fibers to the polyurethane matrix.

Preferably, the frame of the solar panel according to the invention contained in said roofing tile/roofing shingle/facade element comprises at least one flame retardant. “Flame retardants”, as used herein, means, in particular, organic compounds (especially halogenated, phosphorus-containing, such as tricresyl phosphate, tris(2-chloroethyl)phosphate, tris(chloropropyl)phosphate and tris(2,3-dibromopropyl)phosphate, and nitrogen-containing organic compounds) and inorganic phosphorus compounds (for example, red phosphorus, ammonium polyphosphate), inorganic metal hydroxides (for example, aluminum trihydroxide, aluminum oxide hydrate, ammonium polyphosphate, sodium polymetaphosphate or amine phosphates, such as melamine phosphates) and inorganic boron compounds (for example, boric acid, borax).

Examples of commercially available flame retardants that may be applied within the scope of the present invention include, for example: Disflamoll® DPK (diphenyl cresyl phosphate), Levagard® DMPP (dimethylpropane phosphonate), Levagard® PP (tris(2-chloroisopropyl)phosphate), melamine, Exolite® AP 422 (a free-flowing powdery, hardly water-soluble ammonium polyphosphate of formula (NH₄PO₃)ₙ with n=20 to 1000, especially 200 to 1000), Apyral® (Al(OH)₃).

Melamine is particularly preferred as a flame retardant.

Preferably, the frame of the solar module comprises both fillers and flame retardants. The presence of these two ingredients results in good mechanical properties, the solar module at the same time exhibiting sufficient flame-retardant properties.

In order to reduce the weight of a solar roofing tile/solar roofing shingle/solar facade element, it is also possible to insert a rigid foam core on the side of the roofing tile/roofing shingle/facade element facing away from the solar panel. Such a rigid foam core may be introduced while completely enclosed by the polymer concrete. Alternatively, it may have a frame of polyurethane on the backside thereof and laterally/circumferentially having a thickness of from 1 to 5 mm, especially from 2 to 3 mm. This polyurethane-framed rigid foam core can be inserted in a way so as to form the backside termination of said solar roofing tile/solar roofing shingle/solar facade element. Aliphatic and/or aromatic components are employed to form the polyurethane in this case too. By the use of the polyurethane frame, the rigid foam core is permanently attached to the roofing tile/roofing shingle/facade element. Material stresses between the rigid foam core and the roofing tile/roofing shingle/facade element caused by the weather conditions are compensated. In addition to reducing the weight of said roofing tile/roofing shingle/facade element, the rigid foam core also leads to an improved insulation of buildings.

According to the invention, the electrical connections of the solar panel are on the backside of the roofing tile/roofing shingle/facade element. This enables a simple connection to be made between the individual solar panels.

In another embodiment according to the invention, the solar panel is first provided with an adhesion promoter on its backside and laterally/circumferentially and subsequently with an elastomeric frame on its backside and laterally/circumferentially when a solar roofing tile/solar roofing shingle/solar facade element is prepared. A solar panel thus framed with a polyurethane elastomer is then inserted in a mold. The side facing toward the sun in the service condition is placed on the base area of a box-like mold. Subsequently, a polymer/concrete mixture is poured or injected behind the laminate and distributed under vibration, for example, by ultrasound. The distribution under vibration prevents air bubbles from being enclosed in the concrete.

In an alternative method, a solar element provided with an adhesion promoter is directly placed into a two-cavity mold. The side facing toward the sun in the service condition is placed on the base area of a box-like mold. In this mold, the elastomeric frame is applied first. Thereafter, the upper mold of the two-cavity mold is replaced by a larger upper mold corresponding to the volume of the polymer concrete. Into this mold volume that is larger now, the polymer concrete is subsequently introduced and optionally distributed under vibration.

During the curing process, the polymer concrete and the framed photovoltaic solar panel are inseparably connected. The curing process may be accelerated by subsequently tempering in an oven, for example, at 65° C. for 10 minutes.

In both cases, a rigid foam core optionally provided with an elastomeric frame may additionally be inserted into the polymer concrete in the mold while still wet. In this case too, an inseparable connection is produced between the polymer concrete and the framed or completely enclosed rigid foam core during the curing process.

The following Example describes the preparation of a solar roofing shingle/solar roofing tile/solar facade element according to the invention.

### EXAMPLES

A solar roofing shingle was prepared in the following individual steps:

### Example 1

In a first Example, a solar laminate with a backside film was prepared. A 4 mm thick and 150 mm×150 mm sized cured flat glass pane was used as the front layer. Two 480 μm thick EVA films (type Vistasolar® of the company Etimex, Rottenacker, Germany) served as adhesive layers. A silicon solar cell (type Solartec® SC 2450 of the company Solarworld, Dresden, Germany) was placed between these adhesive films. A 350 μm thick Tedlar®/polyester Tedlar® composite sheet (Madico, USA) was used on the backside. The individual components in the order glass pane, EVA film, silicon solar cell, EVA film and finally the Tedlar® PVF composite sheet were laid together to form a laminate and first evacuated at 140° C. for 6 minutes and subsequently compressed into a solar module under a pressure of 1 bar and at 140° C. for 20 minutes in a vacuum laminator (NPC, Tokyo, Japan).

### Example 2

In another Example, a solar laminate with no backside film was prepared. The preparation was performed by analogy with Example 1, but without the Tedlar® PVF composite sheet. In this embodiment, the solar laminate thus merely consisted of glass, EVA film and solar cells.

### Example 3

Both the solar laminates prepared in Example 1 and those prepared in Example 2 were subsequently inserted into a polyurethane mold and enclosed with an elastomeric polyurethane system by injection in such a way that the backside and the lateral edges were completely enclosed with the polyurethane. On the front side (glass side), there was a circumferential finished edge having a width of 10 mm without the solar cell being covered by polyurethane. The thickness of the circumferential polyurethane frame was 3 mm on the backside and 2 mm on the lateral edges and on the front side. The Bayflex® system Bayflex® VP.PU 51BD11/Desmodur® VP.PU 18IF18 of the company Bayer MaterialScience AG, Leverkusen, Germany, was employed. As a reinforcing material in the polyurethane elastomer, 18.5 percent by weight of fibrous wollastonite of the type Tremin® 939.955 of the company Quarzwerke, Frechen, Germany, was used. Additionally, 6.5 percent by weight of fine-crystalline powdery melamine(2,4,6-triamino-1,3,5-triazine) of the BASF SE (Ludwigshafen, Germany) was employed as a flame retardant in the polyurethane elastomer. A laboratory piston metering system was used as a processing system.

The solar laminate thus framed with a polyurethane elastomer was subsequently transferred into a second mold. The side facing toward the sun in the service condition is placed on the base area of a box-like mold. Subsequently, a polymer/concrete mixture is poured behind the solar laminate and distributed under vibration.

The polymer/concrete mixture cured and was thus inseparably connected with the framed laminate.

The polymer/concrete mixture was prepared on the basis of a Baydur GS (VP.PU 85BD11/Desmodur 44V10L) of the BMS AG, Leverkusen, Germany. In a first step, the Baydur polymer system was stirred after manually mixing the ingredients. Subsequently, a previously dried sand mixture was added. The sand mixture consisted of a mixture of equal parts of a fine-grained sand (Cemix® hand-applied plaster, grain size 0.3 to 0.6 mm, Lasselsberger-Gruppe) and a coarser sand (Cemix® dry plaster sand, 0.6 to 1 mm, Lasselsberger-Gruppe). The thus formulated polymer/concrete mixture was then uniformly poured onto the solar laminate.

1.-16. (canceled)

17. A roofing tile, roofing shingle or facade element comprising a photovoltaic solar panel, wherein said solar panel is embedded in polyurethane on the backside thereof and laterally/circumferentially.

18. The roofing tile, roofing shingle or facade element according to claim 17, wherein said solar panel comprises glass, encapsulant film and solar cells.

19. The roofing tile, roofing shingle or facade element according to claim 18, wherein said encapsulant film comprises ethylene-vinyl acetate film, thermoplastic polyurethane film, polyvinylbutyral film and/or silicone encapsulant.

20. The roofing tile, roofing shingle or facade element according to claim 17, further comprising a polymer concrete, especially a concrete containing polyurethane.

21. The roofing tile, roofing shingle or facade element according to claim 20, wherein said polyurethane contained in the polymer concrete has shrinkage during preparation of from 0.9% to 1.5%.

22. The roofing tile, roofing shingle or facade element according to claim 21, wherein said polyurethane contained in the polymer concrete has shrinkage during preparation of 1.2%.

23. The roofing tile, roofing shingle or facade element according to claim 20, wherein said polymer concrete contains from 50 to 85% by weight, of sand.

24. The roofing tile, roofing shingle or facade element according to claim 23, wherein said polymer concrete contains 70% by weight, of sand

25. The roofing tile, roofing shingle or facade element according to claim 23, wherein said sand has a grain size of from 0.3 to 1 mm.

26. The roofing tile, roofing shingle or facade element according to claim 23, wherein the sand-filled polymer concrete has shrinkage of less than 0.5%, especially less than 0.3%.

27. The roofing tile, roofing shingle or facade element according to claim 26, wherein the sand-filled polymer concrete has shrinkage of less than 0.3%.

28. The roofing tile, roofing shingle or facade element according to claim 20, wherein said polymer concrete further contains anti-ageing, flame retardant and coloring agents.

29. The roofing tile, roofing shingle or facade element according to claim 17, wherein the solar panel has an adhesion promoter on the backside and laterally/circumferentially.

30. The roofing tile, roofing shingle or facade element according to claim 17, wherein the solar panel has a frame of polyurethane on the backside and laterally/circumferentially.

31. The roofing tile, roofing shingle or facade element according to claim 30, wherein said frame has a thickness of from 1 to 5 mm, especially from 2 to 3 mm.

32. The roofing tile, roofing shingle or facade element according to claim 30, further comprising aliphatic and/or aromatic components for forming the polyurethanes.

33. The roofing tile, roofing shingle or facade element according to claim 17, further comprising a rigid foam core on the side thereof facing away from the solar panel.

34. The roofing tile, roofing shingle or facade element according to claim 17, wherein electrical connections of the solar panel are on the backside of the roofing tile/roofing shingle/facade element.

35. A process for preparing a roofing tile, roofing shingle or facade element according to claim 17, wherein a solar panel is provided with an adhesion promoter on the backside and laterally/circumferentially, followed by applying an elastomeric polyurethane frame by injection, then placing it into a box-like mold and then introducing polymer concrete.
